(19) United States
(12) Patent Application Publication
(10) Pub. No.: US 2012/0141183 A1
(43) Pub. Date: Jun. 7, 2012

(54) Tape Route Maintaining Mechanism, Tape Cartridge, Tape Printer, And Tape Route Maintaining Method

(75) Inventor: Tomoyuki Kubota, Nagano-ken (JP)

(73) Assignee: SEIKO EPSON CORPORATION, Tokyo (JP)

(21) Appl. No.: 13/307,351

(22) Filed: Nov. 30, 2011

(30) Foreign Application Priority Data
Dec. 1, 2010 (JP) 2010-268352

(51) Int. Cl. B41J 33/10; B65H 57/18

(52) U.S. Cl. 400/194; 242/566

(57) ABSTRACT

A tape route maintaining mechanism for maintaining a predetermined position of a feeding route of a tape-shaped material in a tape processing unit provided to perform predetermined processing for the tape-shaped material, along which route the tape-shaped material drawn from a tape body that contains the tape-shaped material being wound around a tape core, includes: a tape case which is configured to accommodate the tape body such that the tape body can freely rotate; and a route change member provided on the tape case and being configured to change the route of the tape-shaped material drawn from the tape body and to guide the tape-shaped material toward the tape processing unit.

### CROSS-REFERENCE TO RELATED APPLICATION(S)

The present application claims priority from Japanese Patent Application No. 2010-268352, filed on Dec. 1, 2010.

### BACKGROUND

A tape printer is known which includes a roll sheet holder storing portion for receiving a roll sheet holder around which a roll sheet (tape-shaped material) is wound, a platen roller for drawing the roll sheet from the roll sheet holder and feeding the drawn roll sheet, and a thermal head for performing printing on the conveyed roll sheet (see Japanese Patent Publication No.2009-119861).

The roll sheet drawn out of the roll sheet holder passes through a carrying portion provided in the horizontal position before the roll sheet holder storing portion, and reaches the section of the platen roller and the thermal head provided downstream for performing printing. After printing, the roll sheet is discharged to the outside through a sheet outlet port.

According to the tape printer in this related art, however, the draw out start point of the roll sheet (tape-shaped material) shifts toward the axial center in accordance with the decrease in the winding diameter of the roll sheet when the winding number of the roll sheet wound around the roll sheet holder decreases with development of draw out of the roll sheet. In this case, the feeding route of the roll sheet from the draw out start point to the carrying portion constantly varies. Thus, a sufficient space for allowing the change of the feeding route is required in the area from the draw out start point to the carrying portion, which imposes a limitation to miniaturization of the entire printer and increase in the degree of freedom for positioning the internal mechanisms. It is possible to provide a component which changes the feeding direction on the way along the feeding route. In this case, however, such a laborious step for setting the end position of the drawn roll sheet is required so that the roll sheet can pass along an appropriate feeding route at the time of replacement of the roll sheet, for example.

### SUMMARY

Various embodiments may provide a tape route maintaining mechanism, a tape cartridge, a tape printer, and a tape route maintaining method capable of maintaining an appropriate position of a feeding route of a tape-shaped material drawn from a tape body and thereby reducing the entire size and facilitating replacement of the tape body.

According to at least one embodiment of the disclosure, there is provided a tape route maintaining mechanism for maintaining a predetermined position of a feeding route of a tape-shaped material in a tape processing unit provided to perform predetermined processing for the tape-shaped material, along which route the tape-shaped material drawn from a tape body that contains the tape-shaped material being wound around a tape core including: a tape case which is configured to accommodate the tape body such that the tape body can freely rotate; and a route change member provided on the tape case and being configured to change the route of the tape-shaped material drawn from the tape body and to guide the tape-shaped material toward the tape processing unit. Preferably, the route change member is provided at a fixed position on the tape case, the fixed position being fixed in relation to the tape processing unit on the tape case so as to guide the route changed tape-shaped material from the fixed position toward the tape processing unit.

According to at least one embodiment of the disclosure, there is provided a tape route maintaining method for maintaining a predetermined position of a feeding route of a tape-shaped material in a tape processing unit provided to perform predetermined processing for the tape-shaped material, along which route the tape-shaped material drawn from a tape body that contains the tape-shaped material being wound around a tape core, including: accommodating the tape body in a tape case such that the tape body can freely rotate; and changing the route of the tape-shaped material drawn from the tape body at a route change member provided on the tape case and guiding the tape-shaped material toward the tape processing unit.

According to this structure, the route change member for guiding the drawn tape-shaped material toward the tape processing unit is provided on the tape case. In this case, the tape-shaped material can be guided toward the appropriate feeding route only by introducing the tip portion of the drawn tape-shaped material toward the tape processing unit with no attention paid to the feeding route from the draw out start point to the tape processing unit. Accordingly, replacement of the tape body can be facilitated.

It is preferable that the tape core is rotatably supported such as to be rotatable around a horizontal axis, e.g. preferably the horizontal axis of the tape core. Further probably, the tape-shaped material is drawn from a drawing position of the tape body, the drawing position being located near one side of the tape body in the vertical direction. In addition, the route change member is provided on the tape case such as to contact one side of the tape-shaped material drawn from the tape body, which side faces to the other side of the tape body in the vertical direction opposite to the one side of the tape body in the vicinity of which the drawing position of the tape-shaped material is disposed.

According to this structure, the tape-shaped material is drawn from the drawing position near the one side of the tape body in the vertical direction. Thus, the entire tape body can be recognized from the other side of the tape case in the vertical direction. Accordingly, the remaining amount of the tape-shaped material can be easily checked.

The tape route maintaining mechanism is preferably configured such that the tape core is rotatably supported such as to be rotatable around the horizontal axis of the tape core.

Preferably, the tape-shaped material is drawn towards the route change member from a drawing position of the tape body, the drawing position being located at an upper or a lower side of the tape body.

Preferably, the route change member is provided on the tape case such as to contact the upper side of the tape-shaped material drawn from the tape body, if the drawing position is located at the lower side of the tape body. In an alternative preferred embodiment, the route change member is provided on the tape case such as to contact the lower side of the tape-shaped material drawn from the tape body, if the drawing position is located at the upper side of the tape body.

According to at least one embodiment of the disclosure, there is provided a tape cartridge including the tape route maintaining mechanism of the above aspects disposed on a cartridge case.

According to this structure, the tape-shaped material is drawn out in a stable condition from the draw out start position to the tape processing unit. Thus, the tape-shaped material does not jam in the cartridge case.

According to at least one embodiment of the disclosure, there is provided a tape printer configured to accommodate the tape cartridge of the above aspect, and a ribbon cartridge that has a ribbon case accommodating a ribbon core around which an ink ribbon is wound and a winding core around which the drawn ink ribbon is wound, in particular such that ink ribbon drawn from the ribbon core will be wound around the winding core, including; a printing unit provided on the tape processing unit to perform a predetermined printing process for the tape-shaped material while drawing the tape-shaped material from the tape body and feeding the tape-shaped material downstream; and a detecting unit disposed between the tape cartridge and the printing unit at a position away from the ink ribbon exposed through the ribbon cartridge for detecting the presence or absence of the drawn tape-shaped material.

According to this structure, the fixed feeding route of the tape-shaped material from the draw out start point to the tape processing unit (printing unit) is maintained. In this case, the distance between the tape-shaped material lying on the feeding route and the detecting unit becomes constant, which allows secure and stable detection of the tape-shaped material by the detecting unit. Moreover, the detecting unit disposed at a position away from the drawn ink ribbon does not erroneously recognize the ink ribbon as the tape-shaped material. Accordingly, the condition that the tape-shaped material wound around the tape core has been completely drawn out (i.e., finish of tape-shaped material) can be reliably recognized as an occasion for executing appropriate steps such as printing stop and notification of replacement of the tape body.

It is preferable that a contact member is further disposed in the vicinity of a detector of the detecting unit in such a position as to slidingly contact the tape-shaped material so as to allow the detecting unit to perform the detection and maintain a constant distance between the detector and the tape-shaped material.

According to this structure, the tape-shaped material and the contact member can slidingly contact each other, the tape-shaped material sliding on the contact member. In this case, the distance between the tape-shaped material and the detecting unit does not change at any position on the feeding route. Thus, the clearance between the tape-shaped material and the detecting unit can be kept constant even when the position of the tape-shaped material slightly fluctuates on the feeding route during conveyance. Accordingly, secure and stable detection of the tape-shaped material can be achieved.

### BRIEF DESCRIPTION OF THE DRAWINGS

The invention will be described with reference to the accompanying drawings, wherein like reference numbers reference like elements.

FIG. 1 is an exemplary schematic perspective view illustrating the external appearance of a tape printer.

FIG. 2 is an exemplary schematic perspective view illustrating the external appearance of the tape printer to which a tape cartridge and a ribbon cartridge are attached with a cover of the tape printer opened.

FIG. 3 is an exemplary schematic perspective view illustrating the external appearance of the tape printer from which the tape cartridge and the ribbon cartridge are removed with the cover of the tape printer opened.

FIG. 4A is an exemplary schematic cross-sectional view of the tape printer.

FIG. 4B is an exemplary schematic cross-sectional view of a first contact member in a modified example.

FIG. 5A is an exemplary schematic front view of the tape cartridge.

FIG. 5B is an exemplary schematic side view of the tape cartridge.

### DESCRIPTION OF EXEMPLARY EMBODIMENT

A tape printer according to an embodiment of the invention is hereinafter described with reference to the accompanying drawings. The tape printer in this embodiment, to which a tape cartridge containing a printing tape wound in a roll shape and a ribbon cartridge containing an ink ribbon are attached, draws the printing tape and the ink ribbon from the respective cartridges, performs printing on the printing tape fed along with the ink ribbon, and cuts the printed portion of the printing tape to produce a label.

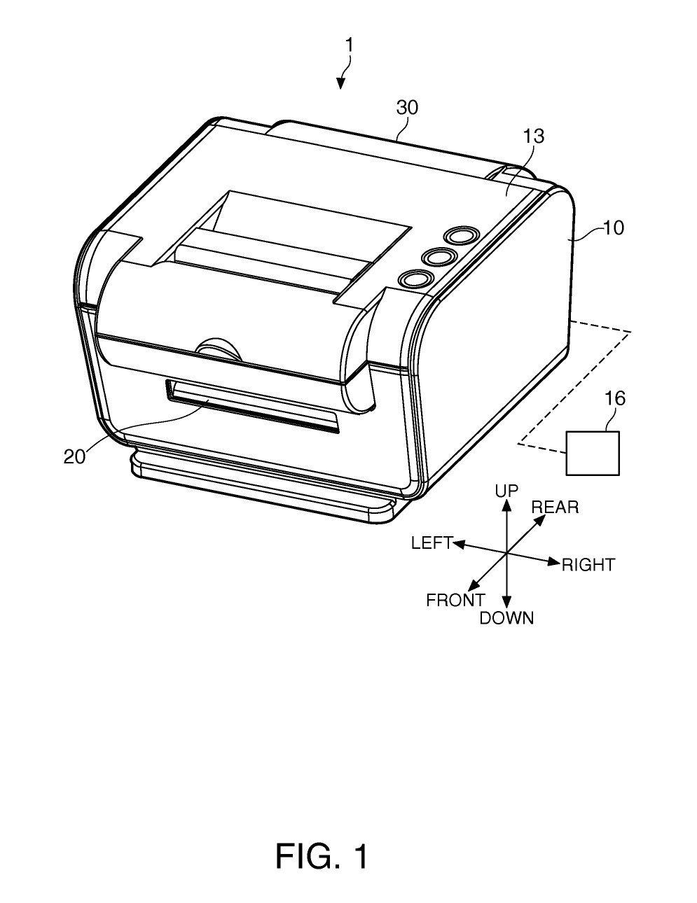

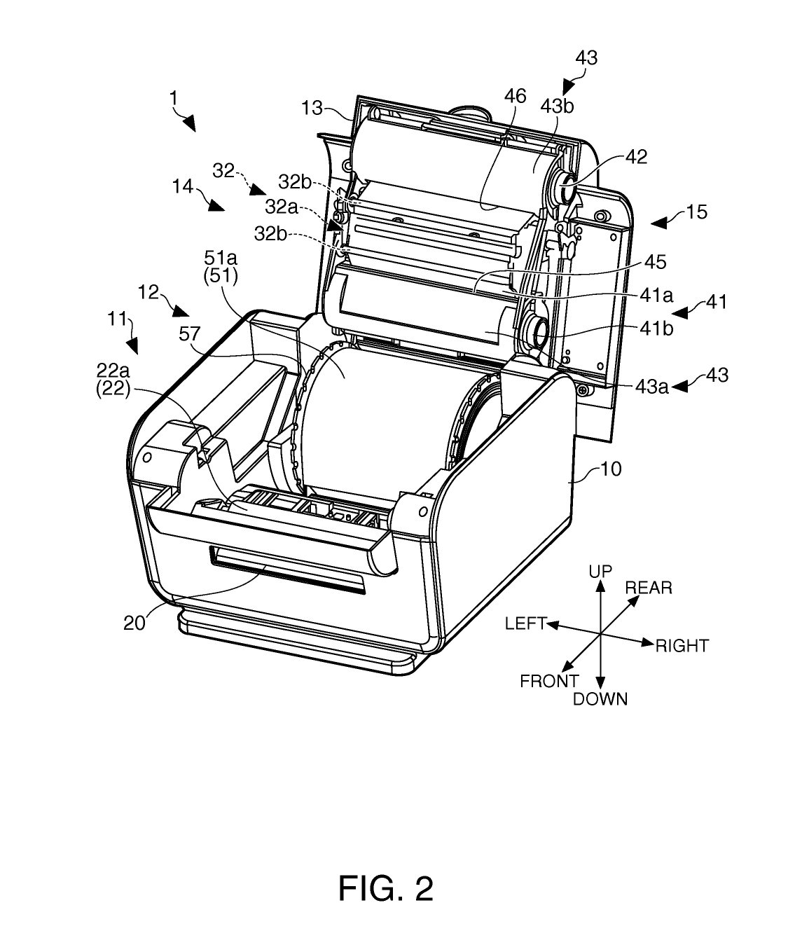

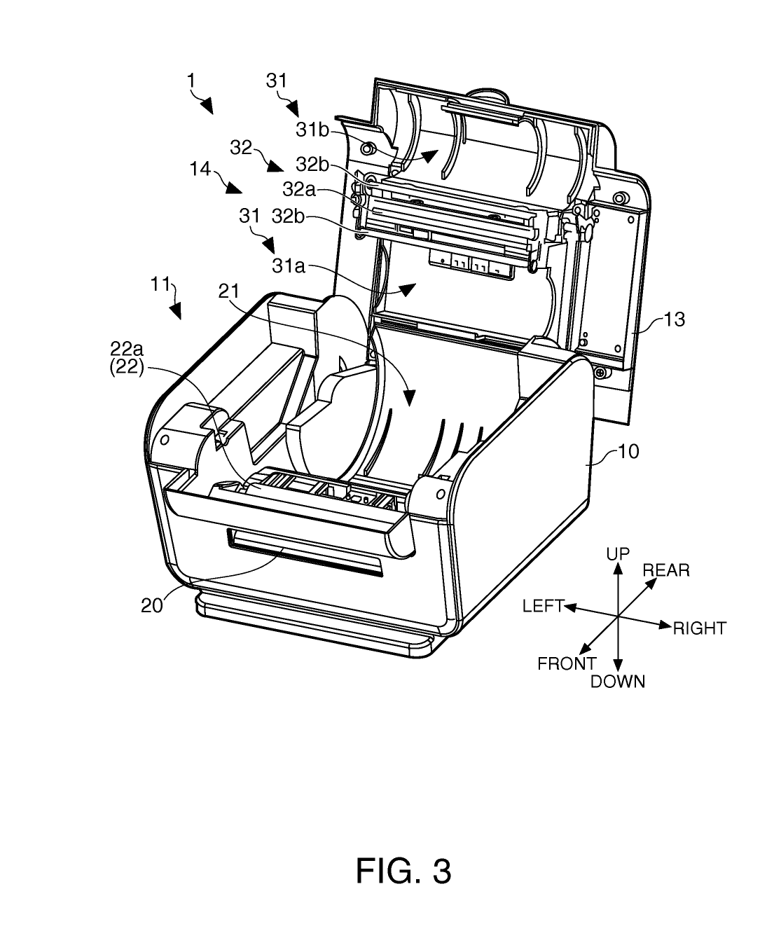

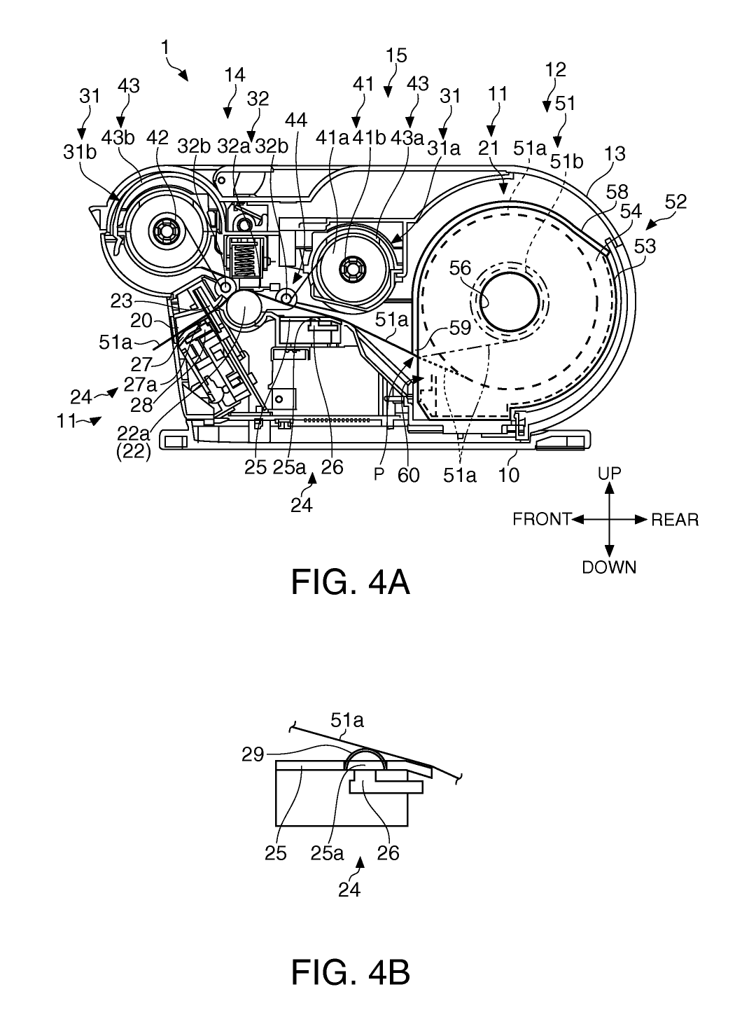

A tape printer 1 is now explained with reference to FIGS. 1 through 4B. FIG. 1 is a perspective view illustrating the external appearance of the tape printer 1. FIG. 2 is a perspective view illustrating the external appearance of the tape printer 1 to which a tape cartridge 12 and a ribbon cartridge 15 are attached with a cover case 13 of the tape printer 1 opened. FIG. 3 is a perspective view illustrating the external appearance of the tape printer 1 from which the tape cartridge 12 and the ribbon cartridge 15 are removed with the cover case 13 is opened. FIG. 4A is a cross-sectional view of the tape printer 1. FIG. 4B is a cross-sectional view of a first contact member 25 on which the tape can slide when being drawn in a modified example. In the following description, the up-down, the front-rear, and the left-right directions coincide with the corresponding directions shown in the respective figures.

As illustrated in FIGS. 1 through 3, the tape printer 1 includes a main body case 10 constituting the main external case, a feeding assembly 11 incorporated inside the main body case 10, the tape cartridge 12 detachably attached to the inside of the feeding assembly 11, the cover case 13 provided in such a manner as to freely open and close to cover the upper part of the main body case 10, a printing assembly 14 incorporated inside the cover case 13, and the ribbon cartridge 15 detachably attached to the inside of the printing assembly 14. The tape printer 1 can be connected with a control device 16 (such as personal computer) operated by a user at the time of execution of printing by using the tape printer 1.

A sheet outlet port 20 is provided at the front center of the main body case 10 as an opening through which a printing tape 51a after printing is discharged to the outside.

The feeding assembly 11 includes a tape attachment portion 21 to which the tape cartridge 12 is attached, a tape feeding mechanism 22 which conveys the printing tape 51a while drawing the printing tape 51a out of the tape cartridge 12, a cutter mechanism 23 which cuts the printing tape 51a after printing, and a tape detecting mechanism 24 which detects the presence or absence of the printing tape 51a drawn onto the feeding route.

The tape attachment portion 21 is a concave formed inside the rear part of the main body case 10 to center the position of the tape cartridge 12 (center in the left-right direction).

The tape feeding mechanism 22 which has a so-called platen roller 22a and a feed driving device (not shown) for rotating the platen roller 22a is disposed before the tape attachment portion 21, in particular, between the sheet outlet port 20 and the position of the attached tape cartridge 12 and/or the tape attachment portion 21. The platen roller 22a contacts the lower surface of the printing tape 51a drawn from the tape cartridge 12 to convey the printing tape 51a toward the sheet outlet port 20 disposed before the platen roller 22a and communicating therewith (see FIG. 4A).

As illustrated in FIG. 4A, the cutter mechanism 23 is a so-called scissors-type cutter unit provided with cutters which face to the printing tape 51a disposed therebetween in directions from above and below, and located before the platen roller 22a. The printing tape 51a after printing is cut by the cutter mechanism. 23, and discharged to the outside through the sheet outlet port 20.

The tape detecting mechanism 24 according to this exemplary embodiment is a so-called reflection type photo sensor which exemplarily includes a first photo-electric element 26 incorporated in the first contact member 25 provided between the tape cartridge 12 and the tape feeding mechanism 22, and a second photo-electric element 28 incorporated in a second contact member 27 disposed to the sheet outlet port 20 before the cutter mechanism 23, exemplarily between the platen roller 22a and the sheet outlet port 20. A “detecting unit” in the appended claims may correspond to the first photo-electric element 26 and/or the second photo-electric element 28.

Each of the first contact member 25 and the second contact member 27 may constitute at least part of the feeding route of the printing tape 51a, and may have a table shape having substantially the same width as the maximum width of the printing tape 51a. The tape 51a can slide on the contact members 25 and 27 when being drawn. A first opening 25a constituting an optical path of the first photo-electric element 26 is formed substantially at the center of the first contact member 25 in the left-right direction. Similarly, a second opening 27a constituting an optical path of the second photo-electric element 28 is formed in the second contact member 27. A detector (light emitting portion and light receiving portion) of the first photo-electric element 26 is disposed within the first opening 25a in such a position as not to project from the upper end surface of the first contact member 25. Similarly, a detector (light emitting portion and light receiving portion) of the second photo-electric element 28 is disposed within the second opening 27a in such a position as not to project from the upper end surface of the second contact member 27. The printing tape 51a after drawn out slidingly contacts the first contact member 25 and the second contact member 27.

The tape detecting mechanism 24 having this structure can detect the presence of the printing tape 51a on the respective contact members 25 and 27, and also can maintain a uniform distance between the printing tape 51a and the respective photo-electric elements 26 and 28 by means of a tape route maintaining mechanism 55 (described later) of the tape cartridge 12. Thus, the clearance between the printing tape 51a and the respective photo-electric elements 26 and 28 can be kept constant even when the position of the printing tape 51a slightly fluctuates on the feeding route during conveyance, which contributes to secure and stable detection of the printing tape 51a.

According to this structure, it is only required that the clearance between the printing tape 51a and the tape detecting mechanism 24 (photo-electric elements 26 and/or 28) is kept constant. Therefore, a substantially semispherical cover 29 may be attached to the first opening 25a of the first contact member 25, for example, as illustrated in FIG. 4B in connection with a modified example. In this case, the cover 29 is preferably transparent so as not to become an obstacle to the detection of the printing tape 51a by the tape detecting mechanism 24. Similarly or alternatively, the cover 29 may be attached to the second contact member 27.

As illustrated in FIG. 2, the tape cartridge 12 has a tape body 51 which contains the printing tape 51a wound around a tape core 51b, and a cartridge case 52 which supports the tape core 51b such that the tape core 51b can freely rotate. The printing tape 51a stored in the tape cartridge 12 can be replaced with the new printing tape 51a including other types having different widths and colors.

As exemplarily illustrated in FIGS. 2 and 4A, the cover case 13 is attached in such a manner that the front part of the cover case 13 can rotate upward around a hinge 30 (see e.g. FIG. 1) provided at the rear end of the cover case 13 and functions as an opening and closing cover to open and close the feeding assembly 11 (tape attachment portion 21). While the cover case 13 is opening, the printing assembly 14 (ribbon attachment portion 31) is exposed to the outside. In this condition, replacement of the tape cartridge 12 and the ribbon cartridge 15 and maintenance of the respective mechanisms can be easily and conveniently carried out.

The printing assembly 14 includes the ribbon attachment portion 31 to which the ribbon cartridge 15 is attached, and a printing mechanism 32 which performs printing on the printing tape 51a.

The ribbon attachment portion 31 has a draw out attachment portion 31a as a concave formed inside the cover case 13 on the rear side of the printing mechanism 32, and a winding attachment portion 31b as a concave formed on the front side of the printing mechanism. 32. Thus, the ribbon cartridge 15 attached to the ribbon attachment portion 31 crosses over the printing mechanism 32.

The printing mechanism 32 according to this embodiment exemplarily includes a so-called thermal head 32a, a head driving mechanism (not shown) which drives and controls the thermal head 32a, and a pair of ribbon route change shafts 32b disposed before and behind the thermal head 32a in such positions as to allow an ink ribbon 41a to face to a heating portion of the thermal head 32a and having a function of changing a running path 44 of the ink ribbon 41a.

As exemplarily illustrated in FIGS. 2 and 4A, the ribbon cartridge 15 includes a ribbon body 41 which contains the ink ribbon 41a wound around a ribbon core 41b, a winding core 42 around which the used ink ribbon 41a is wound, and a ribbon case 43 which supports the ribbon core 41b and the winding core 42 such that these cores 41b and 42 can freely rotate.

The ribbon case 43 has a draw out case portion 43a which stores the ribbon core 41b such that the ribbon core 41b can freely rotate, and a winding case portion 43b which stores the winding core 42 such that the winding core 42 can freely rotate. The draw out case portion 43a and the winding case portion 43b are connected with each other in the front-rear direction with the running path 44 of the ink ribbon 41a interposed therebetween. The ink ribbon 41a drawn from the ribbon body 41 through a ribbon outlet port 45 formed on the draw out case portion 43a passes along the running path 44 while exposed to the outside, and is introduced into a ribbon inlet port 46 provided on the winding case portion 43b to be wound around the winding core 42. The ribbon case 43 may be colored in black and/or other dark colors.

Attachment of the ribbon cartridge 15 to the ribbon attachment portion 31 can be achieved by both attachment of the draw out case portion 43a to the draw out attachment portion 31a and attachment of the winding case portion 43b to the winding attachment portion 31b. In this condition, the ink ribbon 41a drawn onto the running path 44 contacts the thermal head 32a and the pair of the ribbon route change shafts 32b.

The thermal head 32a contacts the printing tape 51a from above with the ink ribbon 41a interposed between the thermal head 32a and the printing tape 51a, while the platen roller 22a contacts the printing tape 51a from below (see FIG. 4A). The printing tape 51a sandwiched between the thermal head 32a and the platen roller 22a with the ink ribbon 41a set between the thermal head 32a and the printing tape 51a passes through the thermal head 32a which performs printing on the printing tape 51a, while being sequentially drawn from the tape body 51 by the rotation of the platen roller 22a. The printing tape 51a after printing is conveyed toward the sheet outlet port 20, while the ink ribbon 41a is wound around the winding core 42. Each of the thermal head 32a and the platen roller 22a has a width substantially equivalent to the maximum width of the printing tape 51a. The winding core 42 and the platen roller 22a rotate in synchronization with each other.

The positional relationship between the first photo-electric element 26 of the tape detecting mechanism 24 and the draw out case portion 43a of the ribbon cartridge 15 is now explained.

The first photo-electric element 26 (more specifically, detector of the first photo-electric element 26) in this embodiment is disposed at a position opposed to the draw out case portion 43a colored in a black and/or dark color. That is, the first photo-electric element 26 disposed at a position away from the positions of the ink ribbon 41a exposed through the ribbon cartridge 15 and the pair of the ribbon route change shafts 32b faces to the lower surface of the printing tape 51a to detect the printing tape 51a lying on the feeding route. In this case, the first photo-electric element 26 does not erroneously recognize the ink ribbon 41a as the printing tape 51a even when the ink ribbon 41a has a color similar to the color of the printing tape 51a. Accordingly, the condition that the printing tape 51a wound around the tape core 51b has been completely drawn out (i.e., tape end detection) can be reliably recognized as an occasion for executing appropriate steps such as printing stop and notification of replacement of the tape cartridge 12. Moreover, accurate alignment can be made when the printing tape 51a is constituted by die cut tapes, for example. Similarly, the second photo-electric element 28 detecting the discharge of the printing tape 51a is disposed opposed to the winding case portion 43b.

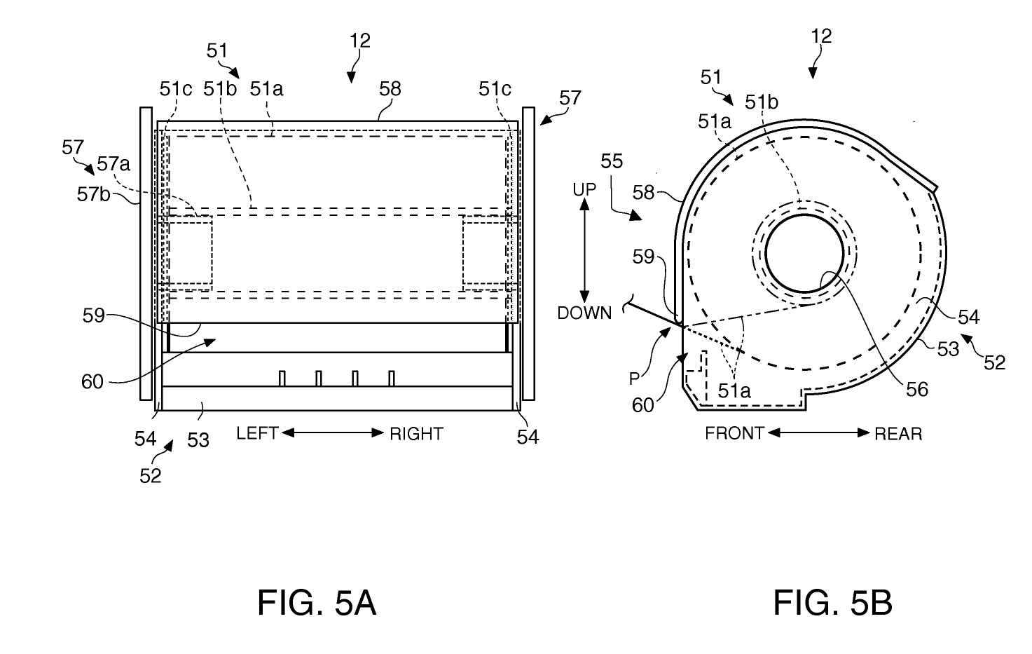

The details of the tape cartridge 12 are now explained with reference to FIGS. 4A through 5B. FIG. 5A is a front view of the tape cartridge 12. FIG. 5B is a side view of the tape cartridge 12. As noted above, the tape cartridge 12 has the tape body 51 and the cartridge case 52.

The tape body 51 contains the printing tape 51a wound around the outer circumference of the hollow and cylindrical tape core 51b. An adhesive sheet 51c is attached to each of both end surfaces of the tape body 51 so as to prevent separation of the printing tape 51a from the wounded body. An axial support member 57 is fitted to each of both ends of the tape core 51b in the axial direction to support the tape body 51 on both side walls 54 (described later) of the cartridge case 52 such that the tape body 51 can freely rotate.

The cartridge case 52 includes a tape receiving portion 53 which receives the circumferential surface of the tape body 51, a pair of the side walls 54 standing on both ends of the tape receiving portion 53 in the left-right direction, a pair of the axial support members 57 which support the tape body 51 on the respective side walls 54, and the tape route maintaining mechanism 55 which maintains a fixed drawing position of the printing tape 51a from the tape body 51.

The tape receiving portion 53 has a curved rear part shaped along the circumferential surface of the tape body 51 to support the sliding movement of the tape body 51 rotated in accordance with draw out of the printing tape 51a. The tape receiving portion 53 is preferably made of synthetic resin so that the tape body 51 can slide more smoothly along the tape receiving portion 53.

Each of the side walls 54 has a bearing opening 56 through which an engaging portion 57a (described later) of the corresponding axial support member 57 is inserted.

Each of the axial support members 57 has the engaging portion 57a engaging with the axial center of the tape core 51b, and a flange-shaped dial portion 57b continuing from the engaging portion 57a. The engaging portions 57a are inserted through the bearing openings 56 from the outside of the side walls 54 to engage with both ends of the tape core 51b in the left-right (axial) direction of the tape core 51b. By this engagement, the respective axial support members 57 and the tape core 51b are fixed to each other such that they cannot shift from each other, and are supported in such a manner as to be rotatable with respect to the bearing openings 56. The respective dial portions 57b are parts rotated by the user to remove looseness of the wound printing tape 51a. FIG. 5B does not show the axial support members 57.

The tape route maintaining mechanism 55 includes a tape case 58 disposed in such a position as to cover the upper part of the tape body 51, and a route change member 59 provided on the tape case 58 to guide the printing tape 51a drawn from the tape body 51 toward the tape feeding mechanism 22 and the printing mechanism 32 while changing the route of the printing tape 51a.

The rear end of the tape case 58 is supported by the tape receiving portion 53, while both ends of the tape case 58 in the left-right direction are supported by the pair of the side walls 54, in which condition the tape case 58 covers the tape body 51. The route change member 59 is provided at the front lower end of the tape case 58. A draw out opening 60 located between the tape receiving portion 53 and the route change member 59 is an opening through which the printing tape 51a is drawn toward the front. In this case, the printing tape 51a is drawn from the draw out opening 60 formed at a lower position of the tape body 51 while slidingly contacting the route change member 59. The contact portion of the route change member 59 is shaped such as not to damage the printing tape 51a, e.g. it is chamfered, in particularly preferably R-chamfered.

According to the tape route maintaining mechanism 55 in this exemplary embodiment, the printing tape 51a is drawn out with route change at the contact portion between the printing tape 51a and the route change member 59 as the winding diameter of the printing tape 51a decreases (diameter decrease) with development of consumption of the printing tape 51a. By this adjustment, the contact point (hereinafter referred to as “draw out start point P”) between the printing tape 51a and the route change member 59 can be maintained at a fixed point. In this case, the draw out start point P of the printing tape 51a does not change (shift) with the diameter decrease of the tape body 51. Thus, the fixed feeding route of the printing tape 51a from the draw out start point P to the tape feeding mechanism 22 and the printing mechanism 32 can be maintained. This structure keeps a constant clearance between the first photo-electric element 26 and the printing tape 51a, thereby preventing erroneous detection of the printing tape 51a. According to this embodiment, the positions of the tape feeding mechanism 22 and the printing mechanism 32 are fixed with respect to the feeding route.

Moreover, the route change member 59 is provided on the tape case 58. According to this structure, the printing tape 51a can be guided toward the appropriate feeding route only by introducing the tip of the drawn printing tape 51a toward the tape feeding mechanism 22 and the like with no attention paid to the feeding route from the draw out start point P to the tape feeding mechanism 22 and the printing mechanism 32. Accordingly, replacement of the tape body 51 can be facilitated.

Furthermore, the printing tape 51a is drawn out from the lower part of the tape body 51. In this case, the entire part of tape body 51 can be recognized from above the tape case 58 when the tape case 58 is made of transparent material or provided with an opening. Accordingly, the remaining amount of the printing tape 51a can be easily checked. When the printing tape 51a is constituted by thermal roll paper, the ribbon cartridge 15 is not required.

What is claimed is:

1. A tape route maintaining mechanism for maintaining a predetermined position of a feeding route of a tape-shaped material in a tape processing unit provided to perform predetermined processing for the tape-shaped material, along which route the tape-shaped material drawn from a tape body that contains the tape-shaped material being wound around a tape core, comprising:
a tape case which is configured to accommodate the tape body such that the tape body can freely rotate; and
a route change member provided on the tape case and being configured to change the route of the tape-shaped material drawn from the tape body and to guide the tape-shaped material toward the tape processing unit.

2. The tape route maintaining mechanism according to claim 1, wherein
the tape core is rotatably supported such as to be rotatable around the horizontal axis of the tape core;
the tape-shaped material is drawn from a drawing position of the tape body, the drawing position being located near one side of the tape body in the vertical direction; and
the route change member is provided on the tape case such as to contact one side of the tape-shaped material drawn from the tape body, which side faces to the other side of the tape body in the vertical direction opposite to the one side of the tape body in the vicinity of which the drawing position of the tape-shaped material is disposed.

3. The tape route maintaining mechanism according to claim 1, wherein
the tape core is rotatably supported such as to be rotatable around the horizontal axis of the tape core.

4. The tape route maintaining mechanism according to claim 1, wherein
the tape-shaped material is drawn towards the route change member from a drawing position of the tape body, the drawing position being located at an upper or a lower side of the tape body.

5. The tape route maintaining mechanism according to claim 4, wherein
the route change member is provided on the tape case such as to contact the upper side of the tape-shaped material drawn from the tape body, if the drawing position is located at the lower side of the tape body.

6. The tape route maintaining mechanism according to claim 4, wherein
the route change member is provided on the tape case such as to contact the lower side of the tape-shaped material drawn from the tape body, if the drawing position is located at the upper side of the tape body.

7. A tape cartridge comprising the tape route maintaining mechanism according to claim 1 disposed on a cartridge case.

8. A tape printer configured to accommodate the tape cartridge according to claim 7, and a ribbon cartridge that has a ribbon case accommodating a ribbon core around which an ink ribbon is wound and a winding core which is configured such that ink ribbon is wound around the winding core, comprising:
a printing unit provided on the tape processing unit to perform a predetermined printing process for the tape-shaped material while drawing the tape-shaped material from the tape body and feeding the tape-shaped material downstream; and
a detecting unit disposed between the tape cartridge and the printing unit at a position away from the ink ribbon exposed through the ribbon cartridge for detecting the presence or absence of the drawn tape-shaped material.

9. The tape printer according to claim 8, further comprising a contact member disposed in the vicinity of a detector of the detecting unit in such a position as to slidingly contact the tape-shaped material so as to allow the detecting unit to perform the detection and maintain a constant distance between the detector and the tape-shaped material.

10. A tape route maintaining method for maintaining a predetermined position of a feeding route of a tape-shaped material in a tape processing unit provided to perform predetermined processing for the tape-shaped material, along which route the tape-shaped material drawn from a tape body that contains the tape-shaped material being wound around a tape core, comprising:
accommodating the tape body in a tape case such that the tape body can freely rotate; and
changing the route of the tape-shaped material drawn from the tape body at a route change member provided on the tape case and guiding the tape-shaped material toward the tape processing unit.
